(19) United States
(12) Patent Application Publication
(10) Pub. No.: US 2010/0079476 A1
(43) Pub. Date: Apr. 1, 2010

(54) IMAGE DISPLAY APPARATUS AND METHOD

(75) Inventors: Masahiro Baba, Kanagawa-ken (JP); Ryosuke Nonaka, Kanagawa-ken (JP); Goh Itoh, Tokyo (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/503,418

(22) Filed: Jul. 15, 2009

(30) Foreign Application Priority Data
Sep. 26, 2008 (JP) 2008-247914

(51) Int. Cl. G09G 3/36; G09G 5/02

(52) U.S. Cl. 345/589; 345/102

(57) ABSTRACT

A largest value is selected from brightness data of sub-pixels of each pixel in an image, and a first light source luminance is calculated using the largest value. An average of the largest value of each pixel is calculated, and a second light source luminance is calculated using the average. By comparing the first light source luminance with the second light source luminance, an output light source luminance as a weighted average of the first light source luminance and the second light source luminance is calculated by setting a larger weight to a smaller one of the first light source luminance and the second light source luminance. A gradation of each sub-pixel is converted using the output light source luminance. A light source unit is controlled to emit the light having the output light source luminance.

### CROSS-REFERENCE TO RELATED APPLICATIONS

This application is based upon and claims the benefit of priority from Japanese Patent Application No. 2008-247914, filed on Sep. 26, 2008; the entire contents of which are incorporated herein by reference.

### FIELD OF THE INVENTION

The present invention relates to an image display apparatus and a method for displaying an image having a high visual contrast by a reduced power consumption.

### BACKGROUND OF THE INVENTION

Recently, an image display apparatus such as a liquid crystal display apparatus is widely used. The image display apparatus prepares a light source and a light modulator to modulate a light intensity from the light source. However, in the image display apparatus, the light modulator does not have ideal modulation characteristic. Especially, in case of displaying an image having a black region, a contrast of the image drops by a light leakage from the light modulator.

In order to suppress drop of the contrast, for example, a luminance of light source is modulated based on the input image, and a gradation of each pixel of the input image is converted (gamma conversion). This technique is disclosed in following references.

JP-A H11-109317 (KOKAI) . . . Reference 1

JP-A 2005-309338 (KOKAI) . . . Reference 2

JP-A 2001-27890 (KOKAI) . . . Reference 3

In above three references, based on the input image, the luminance of the light source and gradation conversion of the input image are controlled. In comparison with an image display apparatus having a fixed light source luminance, a contrast of the displayed image rises. Furthermore, a luminance of the backlight falls based on the input image. As a result, a power consumption of the image display apparatus can be reduced.

However, in the References 1 and 2, a maximum value (gradation) of the input image is detected, a minimum luminance of the light source to display the maximum is determined, and a gradation of each pixel of the input image is converted based on the minimum luminance. Accordingly, even if almost pixels of the input image have a minimum gradation (“0”), if partial pixels of the input image have a maximum gradation (“255”), a light source luminance is set as the maximum. Accordingly, effect to improve the contrast and reduce the power consumption cannot be sufficiently acquired.

On the other hand, in the Reference 3, a gradation of each pixel of the input image is converted based on a maximum and a minimum of the input image, and a light source luminance is determined so that an average of original gradation of each pixel of the input image is equal to an average of converted gradation of each pixel of the input image. Briefly, the light source luminance is determined by the average of original gradation of each pixel of the input image. However, even if the average of original gradation of each pixel of the input image does not change, distribution of original gradation of each pixel of the input image variously exists. As a result, the light source luminance is not suitably set for various distribution of gradation of the input image. Accordingly, effect to improve the contrast and reduce the power consumption cannot be also sufficiently acquired.

### SUMMARY OF THE INVENTION

The present invention is directed to an image display apparatus and a method for raising a visual contrast of the input image by a reduced power consumption.

According to an aspect of the present invention, there is provided an apparatus for displaying an image comprising a plurality of pixels, each pixel comprising a plurality of sub-pixels, each sub-pixel corresponding to each color, the apparatus comprising: a light source unit configured to emit a light having a luminance; a light modulator configured to modulate a transmittance or a reflectance of the light based on a gradation of each sub-pixel; a first calculation unit configured to select a largest value from brightness data of the sub-pixels of each pixel in a region of the image, and calculate a first light source luminance using the largest value; a second calculation unit configured to calculate an average of the largest value of each pixel in the region, and calculate a second light source luminance using the average; a third calculation unit configured to compare the first light source luminance with the second light source luminance, and calculate an output light source luminance as a weighted average of the first light source luminance and the second light source luminance by setting a larger weight to a smaller one of the first light source luminance and the second light source luminance; a gradation conversion unit configured to convert a gradation of each sub-pixel of the region using the output light source luminance; and a control unit configured to output a converted gradation of each sub-pixel of the region to the light modulator, and control the light source unit to emit the light having the output light source luminance.

According to another aspect of the present invention, there is also provided a method for displaying an image comprising a plurality of pixels, each pixel comprising a plurality of sub-pixels, each sub-pixel corresponding to each color, the method comprising: selecting a largest value from brightness data of the sub-pixels of each pixel in a region of the image; calculating a first light source luminance using the largest value; calculating an average of the largest value of each pixel in the region; calculating a second light source luminance using the average; comparing the first light source luminance with the second light source luminance; calculating an output light source luminance as a weighted average of the first light source luminance and the second light source luminance by setting a larger weight to a smaller one of the first light source luminance and the second light source luminance; converting a gradation of each sub-pixel of the region using the output light source luminance; outputting a converted gradation of each sub-pixel of the region to a light modulator to modulate a transmittance or a reflectance of a light from a light source unit; and controlling the light source unit to emit the light having the output light source luminance.

### BRIEF DESCRIPTION OF THE DRAWINGS

FIG. 1 is a block diagram of an image display apparatus according to a first embodiment.

FIG. 2 is a block diagram of a first light source luminance calculation unit 20 in FIG. 1.

FIG. 3 is a block diagram of a modification of the first light source luminance calculation unit 20.

FIG. 4 is a block diagram of a second light source luminance calculation unit 22 in FIG. 1.

FIG. 5 is a block diagram of a modification of the image display apparatus according to the first embodiment.

FIG. 6 is a block diagram of a first modification of the second light source luminance calculation unit 22.

FIG. 7 is a block diagram of a second modification of the second light source luminance calculation unit 22.

FIG. 8 is a first graph representing relationship between the first light source luminance and the second light source luminance according to the first embodiment.

FIG. 9 is a second graph representing relationship between the first light source luminance and the second light source luminance according to the first embodiment.

FIG. 10 is a graph in which a vertical axis represents a difference ΔI between the first light source luminance and the second light source luminance, and a horizontal axis represents a weight λ according to a second embodiment.

FIG. 11 is a graph representing relationship between the first light source luminance and the second light source luminance according to the second embodiment.

FIG. 12 is a block diagram of the image display apparatus according to a third embodiment.

FIG. 13 is a schematic diagram of a backlight according to the third embodiment.

FIG. 14 is a first graph representing relationship between a light source and a luminance according to the third embodiment.

FIG. 15 is a second graph representing relationship between the light source and the luminance according to the third embodiment.

FIG. 16 is a block diagram of a modification of a luminance distribution calculation unit 36 in FIG. 12.

### DETAILED DESCRIPTION OF THE EMBODIMENTS

Hereinafter, embodiments of the present invention will be explained by referring to the drawings. The present invention is not limited to the following embodiments.

### The First Embodiment

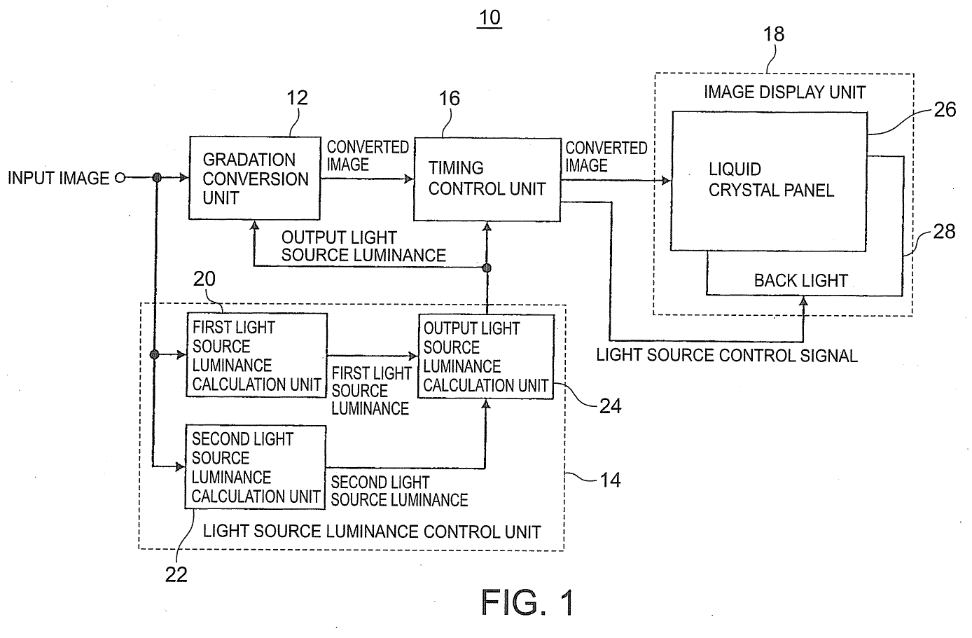

An image display apparatus 10 of the first embodiment is explained by referring to FIGS. 1˜9.

(1) Component of the Image Display Apparatus 10:

As shown in FIG. 1, the image display apparatus includes a gradation conversion unit 12, a light source luminance control unit 14, a timing control unit 16, and an image display unit 18.

The light source luminance control unit 14 includes a first light source luminance calculation unit 20, a second light source luminance calculation unit 22, and an output light source luminance calculation unit 24. The image display unit 18 is a liquid crystal display unit, which is contained of a liquid crystal panel 26 (a light modulator) and a backlight 28 (a light source) set at the back of the liquid crystal panel. Image data of an input image is inputted to the gradation conversion unit 12 and the light source luminance control unit 14.

In the light source luminance control unit 14, the first light source luminance calculation unit 20 calculates a first light source luminance, and the second light source luminance calculation unit 22 calculates a second light source luminance. The first light source luminance and the second light source luminance are inputted to the output light source luminance calculation unit 24. The output light source luminance calculation unit 24 calculates an output light source luminance as a weighted average of the first light source luminance and the second light source luminance. The output light source luminance is inputted to the gradation conversion unit 12 and the timing control unit 16.

The gradation conversion unit 12 converts a gradation of each pixel of the input image data based on the output light source luminance, and outputs converted image data. The timing control unit 16 controls an output timing of the converted image data (converted by the gradation conversion unit 12) and an output timing of the output light source luminance (calculated by the light source luminance control unit 14). Briefly, the timing control unit 16 outputs the converted image data to the liquid crystal panel 26, and outputs a light source control signal as the output light source control to the backlight 28. In the image display unit 18, the converted image data is written into the liquid crystal panel 26. Furthermore, by the backlight 28 emitting based on the light source control signal, the input image is displayed on the image display unit 18.

Next, processing of each unit is explained in detail. A function of each unit can be realized by a program transmitted or stored into a computer.

(2) The Light Source Luminance Control Unit 14:

In the light source luminance control unit 14, the output light source luminance to set to the backlight 28 is calculated from image data of the input image.

(2-1) The First Light Source Luminance Calculation Unit 20:

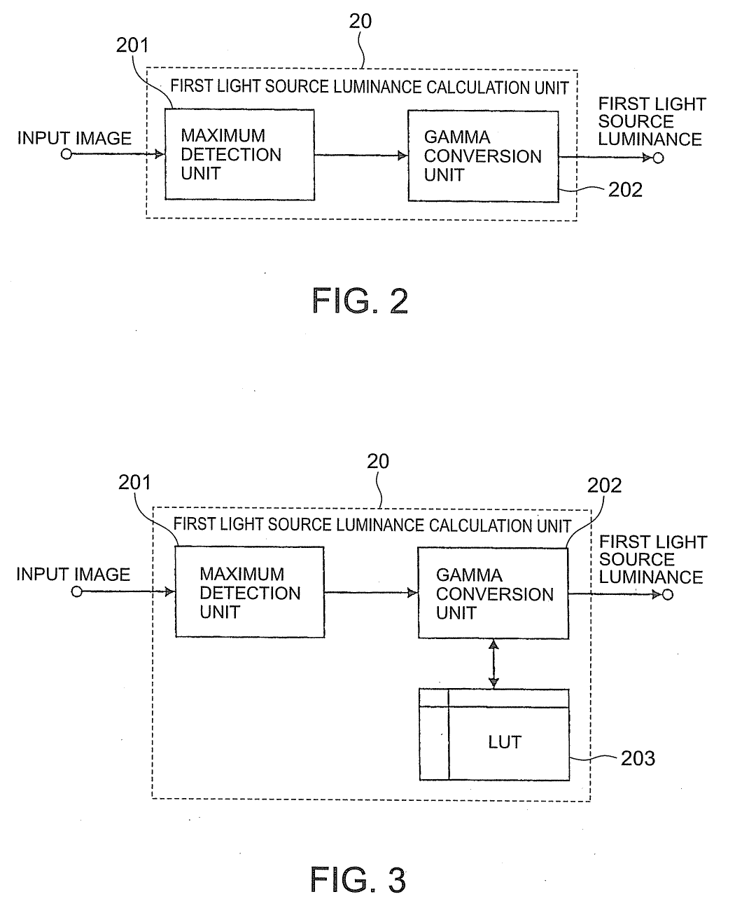

The first light source luminance calculation unit 20 calculates a first light source luminance based on a maximum of brightness data of the input image. As shown in FIG. 2, the first light source luminance calculation unit 20 includes a maximum detection unit 201 and a gamma conversion unit 202. In this case, “brightness data” is a luminance, a logarithmic luminance, a gradation value, or a brightness of each pixel of the input image. Hereinafter, the gradation value is explained as the brightness data.

First, the maximum detection unit 201 detects a maximum from gradation values of sub-pixels (red, green, blue) of each pixel in the input image. Next, the maximum detection unit 201 detects a maximum gradation value from maximums of each pixel of the input image. The gamma conversion unit 202 converts the maximum gradation value to a first light source luminance I₁ (maximum luminance) by gamma conversion. As to the maximum gradation value Lₘₐₓ, the first light source luminance I₁ is calculated by an equation (1).

$${I}_{1} = {( \frac{{L}_{max}}{255} )}^{γ} \qquad ( 1 )$$

In the equation (1), “γ” is a gamma value, and “2.2” is generally used. One value as the first light source luminance I₁ is assigned to one input image.

The first light source luminance calculation unit 14 may be composed as shown in FIG. 3. Briefly, a relationship between the maximum gradation value Lₘₐₓ and the first light source luminance I₁ is previously determined and stored in a LUT (Look Up Table) contained of an ROM (a Read Only Memory). After the maximum gradation value Lₘₐₓ is determined, by referring to the LUT 2034 with the maximum gradation value Lₘₐₓ, the first light source luminance I₁ may be retrieved.

(2-2) The Second Light Source Luminance Calculation Unit 22:

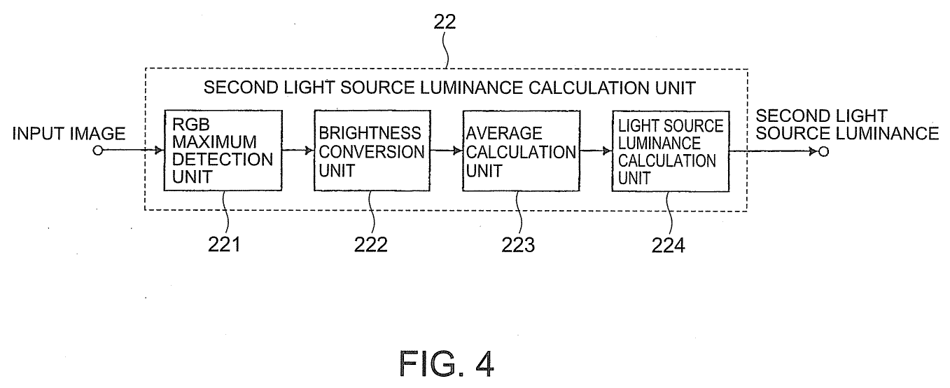

The second light source luminance calculation unit 22 calculates a second light source luminance based on an average of brightness data of the input image. As shown in FIG. 4, the second light source luminance calculation unit 22 includes a RGB maximum detection unit 221, a brightness conversion unit 222, an average calculation unit 223, and a light luminance calculation unit 224.

(2-2-1) The RGB Maximum Detection Unit 221:

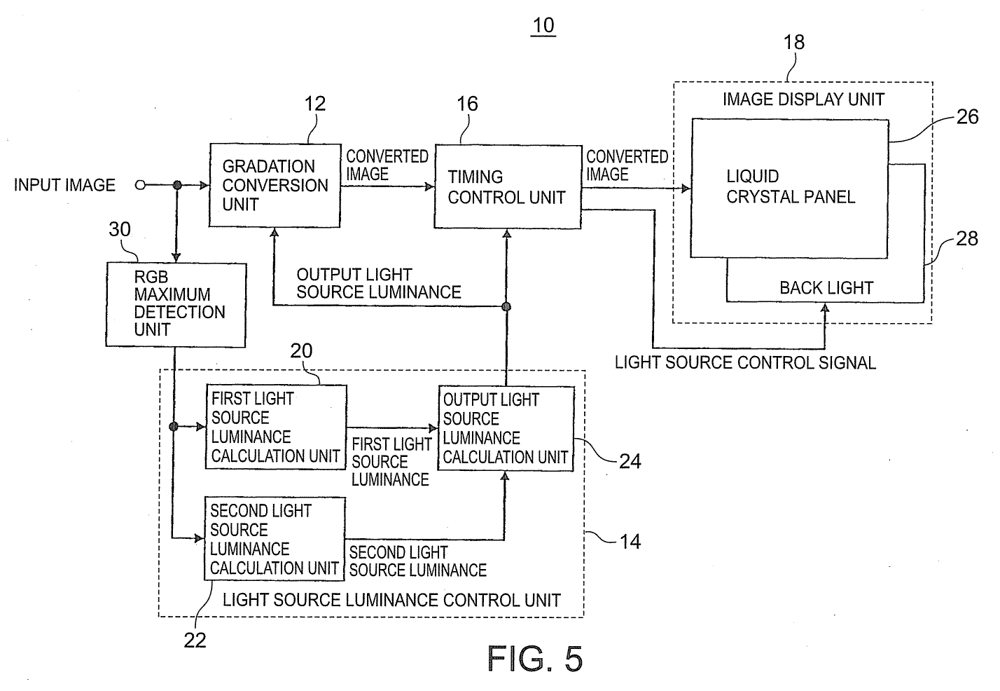

First, the RGB maximum detection unit 221 detects a maximum from gradation values of sub-pixels (red, green, blue) of each pixel in the input image. In the first embodiment, as to the first light source luminance calculation unit 20 and the second light source luminance calculation unit 22, a maximum is detected from gradation values of sub-pixels (red, green, blue) of each pixel. However, as shown in FIG. 5, an RGB maximum detection unit 30 to detect a maximum from gradation values of sub-pixels (red, green, blue) of each pixel may be prepared. In this case, the maximum of gradation values of sub-pixels of each pixel is input to the first light source luminance calculation unit 20 and the second light source luminance calculation unit 22.

(2-2-2) The Brightness Conversion Unit 222:

Next, an average of the input image is calculated from the maximum of gradation value of sub-pixels of each pixel. As a method for calculating the average, the average may be calculated from a gradation value of each sub-pixel or calculated from a luminance by converting the gradation value to the luminance. In the first embodiment, the brightness conversion unit 222 converts a gradation value of the input image to a lightness V_{L*}, and calculates an average of the lightness V_{L*}. A method for calculating the lightness V_{L*} is represented as a following equation (2).

$${V}_{{L}^{*}} ( x , y ) = {( \frac{{l}_{max} ( x , y )}{255} )}^{γ / 3} \qquad ( 2 )$$

In the equation (2), “lₘₐₓ(x,y)” represents a maximum of the gradation value of sub-pixels at a position (x,y) of the input image, “γ” represents a gamma value, and “V_{L*}(x,y)” represents a lightness at the position (x,y) of the input image. Briefly, “lₘₐₓ(x,y)” is the gradation value having eight bits, and “V_{L*} (x,y)” is the lightness having a range “0˜1”. Strictly speaking, the lightness is standardized by CIE (International Commission on Illumination) and non-linearly changes in a dark region. However, in the equation (2), the lightness is easily in proportion to one third power.

Furthermore, as a modification, the average may be calculated with a luminance. In this case, the luminance V_{L} is calculated by a following equation (3).

$${V}_{L} ( x , y ) = {( \frac{{l}_{max} ( x , y )}{255} )}^{γ} \qquad ( 3 )$$

In the equation (3) , “V_{L}(x,y)” represents a luminance at a position (x,y) of the input image.

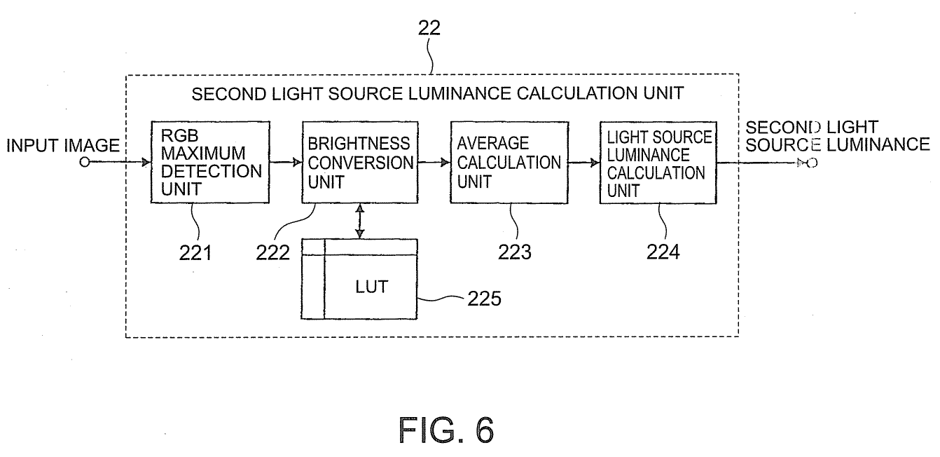

Furthermore, as another modification, instead of the equation (2), the second light source luminance calculation unit 22 may have component shown in FIG. 6. In this case, relationship between a maximum gradation value lₘₐₓ(x,y) and a lightness V_{L*}(x,y) is previously determined and stored in an LUT 225. By referring to the LUT 225 with the maximum gradation value lₘₐₓ(x,y), the lightness V_{L*}(x,y) is searched.

(2-2-3) The Average Calculation Unit 223:

After a lightness of each pixel on an input image is calculated, the average calculation unit 223 calculates an average V_{L*} of lightness by following equation (4).

$${V}_{{L}^{*}} = \frac{{\sum }_{y = 0}^{Y - 1} {\sum }_{x = 0}^{X - 1} {v}_{{L}^{*}} ( x , y )}{XY} \qquad ( 4 )$$

In the equation (4) “V_{L*}” represents an average of lightness, and “X” and “Y” represent the number of pixels along a horizontal direction and along a vertical direction on the input image respectively. In case of calculating the average from a luminance, the lightness V_{L*}(x,y) and the average V_{L*} of the brightness are replaced with a luminance V_{L}(x,y) and an average V_{L} of the luminance.

(2-2-4) The Light Source Luminance Calculation Unit 224:

Next, the light source luminance calculation unit 224 calculates a second light source luminance I₂ based on the average. Concretely, the second light source luminance is calculated so that the average is approximately equal to a median between the minimum and the maximum displayable on the image display unit 18. As mentioned-above, in case of calculating the average of lightness, the second light source luminance is calculated so that the average of lightness is approximately equal to a median between the minimum and the maximum of the lightness displayable on the image display unit 18.

For example, with regard to the average V_{L*} calculated from the lightness, calculation flow of the second light source luminance is explained. First, when the light source luminance is the largest value (=1) , the minimum Dₘᵢₙ, the maximum Dₘₐₓ and the median D_{med} of lightness displayable on the image display unit 18 are calculated by an equation (5). The light source luminance is represented as a relative value, i.e., the largest value “1”, the smallest value “0”. Briefly, with regard to the lightness displayable on the image display unit 18, Dₘᵢₙ, Dₘₐₓ and D_{med} are calculated as follows.

$${D}_{min} = {( \frac{1}{CR} )}^{1 / 3} \\ {D}_{max} = 1 \\ {D}_{med} = \frac{{D}_{mim} + {D}_{max}}{2} \qquad ( 5 )$$

In the equation (59, “CR” represents a contrast ratio of the liquid crystal panel 26. Then, the second light source luminance I2 to set the average V_{L*} as the median of the lightness displayable on the image display unit 18 is calculated by an equation (6).

$${I}_{2} = {( \frac{{V}_{{L}^{*}}}{{D}_{med}} {D}_{max} )}^{3} \qquad ( 6 )$$

In above explanation, the median is set as a half (=0.5) of sum of the minimum and the maximum. However, the median may not strictly be the half, but be within 0.4˜0.6 of the sum of the minimum and the maximum.

(2-2-5) Modification 1 of the Light Source Luminance Calculation Unit 224:

In case of calculating the average V_{L} of luminance as brightness data, the second light source luminance I₂, the minimum Dₘᵢₙ, the maximum Dₘₐₓ and the median D_{med} (of lightness displayable on the image display unit 18) are calculated by an equation (7).

$${D}_{min} = \frac{1}{CR} \\ {D}_{max} = 1 \\ {D}_{med} = \frac{{D}_{min} + {D}_{max}}{2} \\ {I}_{2} = \frac{{V}_{L}}{{D}_{med}} {D}_{max} \qquad ( 7 )$$

(2-2-6) Modification 2 of the Light Source Luminance Calculation Unit 224:

In general, human's sense for brightness is in proportion to a logarithm of luminance. Accordingly., by converting the average (calculated from luminance) to a logarithm as brightness data, the second light source luminance may be calculated so that an average of a logarithmic luminance (on a logarithmic space) of the input image is equal to a median of the logarithmic luminance displayable on the image display unit 18. In this case, the second light source luminance I₂, the minimum Dₘᵢₙ, the maximum Dₘₐₓ and the median D_{med} (of logarithmic lightness displayable on the image display unit 18) are calculated by an equation (8).

$${D}_{min} = log \frac{1}{CR} \\ {D}_{max} = log 1 \\ {D}_{med} = \frac{{D}_{min} + {D}_{max}}{2} \\ {I}_{2} = {10}^{log {V}_{L} - {D}_{med} + {D}_{max}} = {V}_{L} \cdot {CR}^{1 / 2} \qquad ( 8 )$$

(2-2-7) Modification 3 of the Light Source Luminance Calculation Unit 224:

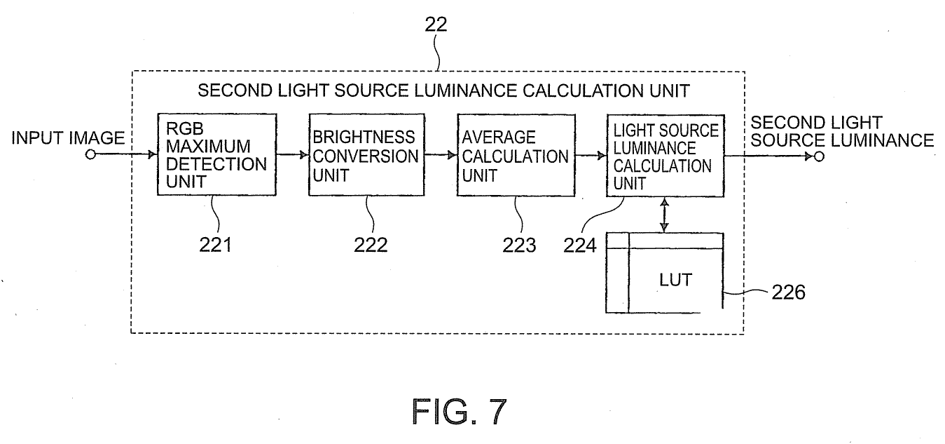

As shown in FIG. 7, the second light source luminance I₂ can be calculated by referring to an LUT 226. Briefly, relationship between the average V_{L*} and the second light source luminance L₂ is previously determined and stored in the LUT 226. After calculating the average V_{L*}, the second light source luminance I₂ may be calculated by referring to the LUT 226 with V_{L*}.

(3) The Output Light Source Luminance Calculation Unit 24:

The output light source luminance calculation unit 24 calculates an output light source luminance I from the first light source luminance I₁ and the second light source luminance I₂. The output light source luminance I is calculated as a weighted sum of the first light source luminance I₁ and the second light source luminance I₂ by an equation (9).

I=λ I₁+(1−λ)I₂ (9)

In the equation (9), “λ” is a weight within “0˜1”. A method for determining λ is variously considered. In the present embodiment, by comparing the first light source luminance I₁ and the second light source luminance I₂, λ is determined so that smaller one is set as the output light source luminance. Briefly, λ is determined by an equation (10).

$$λ = \{ \begin{matrix}1 & {I}_{1} ≺ {I}_{2} \\ 0 & otherwise\end{matrix} \qquad ( 10 )$$

In this way, the output light source luminance I is input to the gradation conversion unit 12 and the timing control unit 16.

(4) The Gradation Conversion Unit 12:

The gradation conversion unit 12 calculates converted image data by converting a gradation value of each pixel of the input image based on the output light source luminance I.

With regard to the output light source luminance I (calculated by the light source luminance control unit 14), a luminance has dropped. In order to acquire a desired brightness, a transmittance of the liquid crystal panel 26, i.e., a gradation value, need be converted. A gradation value of sub-pixel (red, green, blue) at a position (x,y) of the input image is L_{R}(x,y), L_{G}(x,y) and L_{B}(x,y) respectively. In this case, a converted gradation value of sub-pixel (red, green, blue) is calculated by an equation (11).

$${L}_{{R}^{′}} ( x , y ) = \frac{{L}_{R} ( x , y )}{{I}^{1 / γ}} \\ {L}_{{G}^{′}} = ( x , y ) = \frac{{L}_{G } ( x , y )}{{I}^{1 / γ}} \\ {L}_{{B}^{′}} = ( x , y ) = \frac{{L}_{B } ( x , y )}{{I}^{1 / γ}} \qquad ( 11 )$$

In the equation (11), L_{R′}(x,y), L_{G′}(x,y) and L_{B′}(x,y) are the converted gradation value respectively. By executing above-mentioned processing to each gradation value of the input image, the converted image data is generated and input to the timing control unit 16.

(4-1) Modification 1:

With regard to the converted gradation value, except for the equation (11), for example, relationship among a gradation value L, an output light source luminance I and a converted gradation value L′ is previously determined and stored in the LUT. By referring to the LUT with the gradation value L(x,y) and the output light source luminance I, the converted gradation value L′(x,y) may be searched.

(4-2) Modification 2:

In the equation (11), the converted gradation value L′ is often above a maximum gradation value (255) of the liquid crystal panel 26 by the gradation value L and the output light source luminance I. In this case, For example, the converted gradation value may be saturated as 255. However, with regard to the converted gradation value saturated, gradation clipping occurs. Accordingly, as another modification, the converted gradation value (stored in the LUT) may be corrected to smoothly change at a range including the saturated gradation value.

(4-3) Modification 3:

The output light source luminance I is calculated using gradation values of all pixels of the input image (one frame) by the light source luminance control unit 14. At timing when the input image is input to the gradation conversion unit 12, the output light source luminance corresponding to the input image is not calculated yet. Accordingly, the gradation conversion unit 12 prepares a frame memory to temporarily store the input image, and generates the converted image data based on the output light source luminance after delaying one frame period.

However, in general, input image data temporarily continues to some extent. Accordingly, for example, with regard to a present input image (present frame), the converted image data may be generated by the output light source luminance calculated from a previous input image (previous frame). In this case, the gradation conversion unit 12 need not delay the present input image for one frame period. As a result, the frame memory is not necessary, and a circuit scale can be reduced.

(5) The Timing Control Unit 16:

The timing control unit 16 controls timing to write the converted image data into the liquid crystal panel 26 and to apply the output light source luminance to the backlight 28. The converted image data is sent to the liquid crystal panel 26 with synchronizing signals such as a horizontal synchronizing signal and a vertical synchronizing signal (generated by the timing control unit 16) to drive the liquid crystal panel 26. At the same time, a light source control signal to light the backlight 28 with a desired luminance is generated based on the output light source luminance, and sent to the backlight 28.

The light source control signal is different by a type of a light source set on the backlight 28. In general, a cold cathode fluorescence lamp or a light emitting diode (LED) is used as the light source of the backlight 28. By controlling a voltage or an electric current to be applied, a luminance of the light source can be modulated.

In general, PWM (Pulse Width Modulation) to modulate a luminance by quickly switching a luminance period and a non-luminance period is used. In the present embodiment, an LED light source having a luminance intensity easily controlled is used as the light source of the backlight 28, and a luminance of the LED light source is modulated by PWM control. Accordingly, the timing control unit 16 generates a PWM control signal based on the output light source luminance, and outputs the PWM control signal as the light source control signal to the backlight 28.

(6) The Image Display Unit 18:

As mentioned-above, the image display unit 18 contains the liquid crystal panel 26 as a light modulator and the backlight 28 (to modulate a luminance of the light source) set on the back of the liquid crystal panel 26. The image display unit 18 writes converted image data (output from the timing control unit 16) into the liquid crystal panel 26 (light modulator), and lights the backlight 28 based on the light source control signal (output from the timing control unit 16) to display the input image. In the present embodiment, LED light source is used as a light source of the backlight 28.

(7) Effect:

Hereinafter, effect of the present embodiment is explained.

(7-1) The First Explanation:

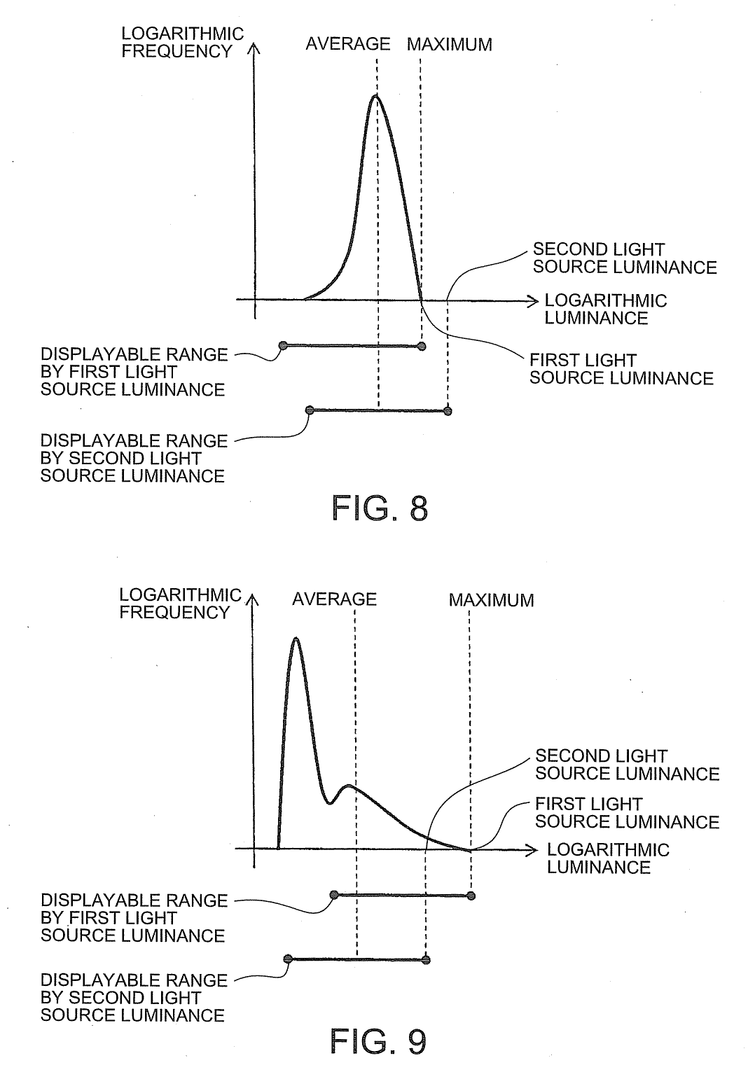

First, the case that a histogram of an input image is shown in FIG. 8 is explained. In FIG. 8, a horizontal axis represents a logarithmic luminance and a vertical axis represents a logarithmic frequency (logarithm of the number of pixels).

As shown in FIG. 8, if a distribution of gradation value of input image is narrow, a maximum of luminance is near an average of luminance. With regard to the first light source luminance (based on the maximum of luminance), a luminance of the backlight 28 is fallen to a level that the maximum of the input image can be displayed. Accordingly, the maximum of the input image is the first light source luminance. When a luminance of the backlight 28 is set by the first light source luminance, a displayable range of the image display unit 18 is shown in FIG. 8.

On the other hand, with regard to the second light source luminance, a luminance of the backlight 28 is calculated so that an average of the luminance of the input image is at a center of displayable range of the image display unit 18. As a result, the second light source luminance is higher than the first light source luminance as shown in FIG. 8. In this case, a maximum of displayable range of the image display unit 18 by the second light source luminance is higher than a maximum of luminance of the input image. In comparison with the case that the image display unit 18 displays the image by the first light source luminance, a power consumption of the case that the image display unit 18 displays the image by the second light source luminance increases.

In FIG. 8, a gradation value of the input image is correctly displayed by the first light source luminance. Briefly, as to gradation values that the first light source luminance is smaller than the second light source luminance, by setting the first light source luminance as the output light source luminance, the power consumption can be further reduced.

(7-2) The Second Explanation:

Next, the case that the input image is shown as a histogram of FIG. 9 is explained. In FIG. 9, a distribution of a gradation value of the input image is wide, and an average of luminance is apart from a maximum of luminance. With regard to the first light source luminance (based on the maximum of luminance), a displayable range of the image display unit 18 is shown in FIG. 9. In this case, gradation values mainly included in the input image are outside the displayable range of the image input unit 18.

On the other hand, with regard to the second light source luminance (based on the average of luminance), a displayable range of the image input unit 18 is set on a region of gradation values having high frequency in the input image. In other words, as shown in FIG. 9, gradation values having high frequency are within the displayable range of the image display unit 18. A gradation value of the maximum in the input image is outside the displayable range by the second light source luminance. However, a frequency of the gradation value outside the displayable range by the second light source luminance is smaller than a frequency of the gradation value outside the displayable range by the first light source luminance. Accordingly, image quality is less affected.

Briefly, as to gradation values that the second light source luminance is smaller than the first light source luminance, by setting the second light source luminance as the output light source luminance, the power consumption can be further reduced while the image quality is highly kept.

As mentioned-above, in the first embodiment, as to various input images, the image display apparatus 10 which displays an image having a high visual contrast with a reduced power consumption can be presented.

### The Second Embodiment

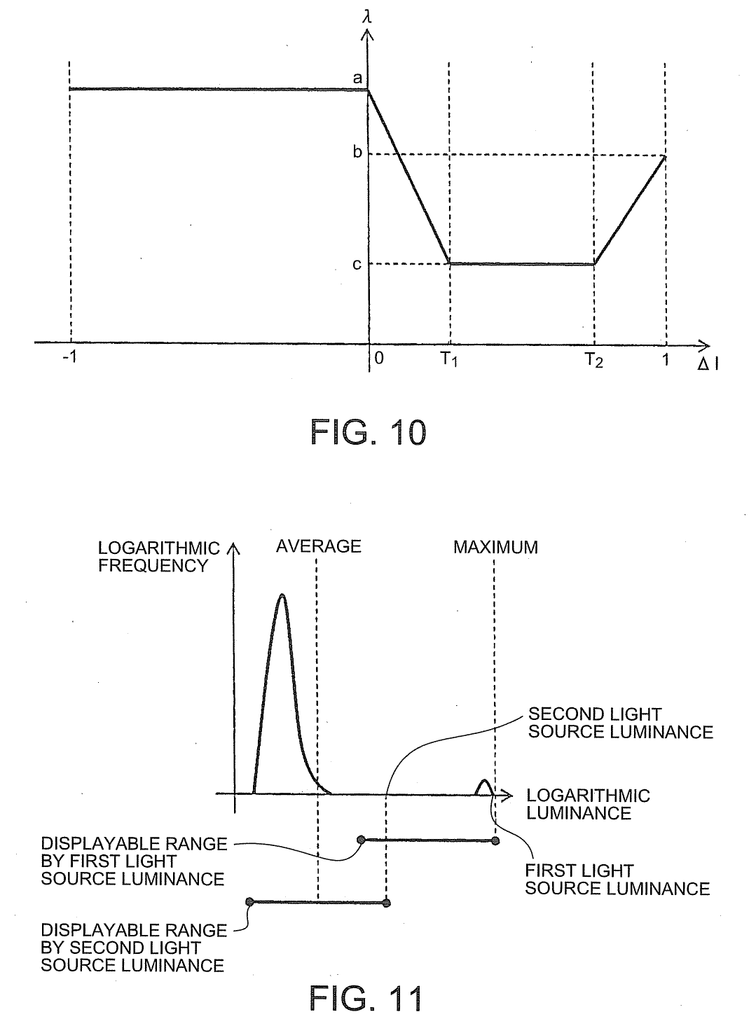

Hereinafter, the image display apparatus of the second embodiment is explained by referring to FIGS. 10 and 11. Basic component of the image display apparatus 10 is same as the first embodiment. However, a method for setting a weight to calculate the output light source luminance from the first light source luminance and the second light source luminance is different. Accordingly, the method for setting the weight is explained in detail. Other units of the second embodiment are same as the first embodiment, and their explanations are omitted.

(1) The Output Light Source Luminance Calculation Unit 24:

The output light source luminance calculation unit 24 calculates an output light source luminance as a weighted average of the first light source luminance and the second light source luminance. In the first embodiment, by comparing the first light source luminance with the second light source luminance, the weight is set to calculate the smaller one as the output light source luminance.

On the other hand, in the second embodiment, the weight is set based on a difference between the first light source luminance and the second light source luminance. Briefly, as to the difference ΔI between the first light source luminance and the second light source luminance, the output light source luminance I is calculated by an equation (12).

I=λ(ΔI)I₁+(1−λ(ΔI))I₂ (12)

ΔI=I₁−I₂

In the equation (12), “(ΔI)” represents a weight determined by ΔI. A method for setting a weight function λ(ΔI) is variously considered. In the second embodiment, the weight shown in FIG. 10 is set.

In FIG. 10, a horizontal axis represents the difference ΔI between the first light source luminance and the second light source luminance, and a vertical axis represents a weight λ. In case of “ΔI<0”, the first light source luminance is smaller than the second light source luminance. In case of “ΔI>0”, the second light source luminance is smaller than the first light source luminance. In the first embodiment, “T₁” is 0, “T₂” is 1, “a” is 1, and “c” is 0 in FIG. 10. FIG. 10 is represented by expressions as a following equation (13).

$$λ ( Δ I ) = \{ \begin{matrix}a & Δ I ≺ 0 \\ \frac{c - a}{{T}_{1}} Δ I & 0 \leq Δ I ≺ {T}_{1} \\ c & {T}_{1} \leq Δ I ≺ {T}_{2} \\ \frac{b - 1}{1 - {T}_{2}} ( Δ I - 1 ) + b & Δ I \geq {T}_{2}\end{matrix} \qquad ( 13 )$$

For example, in the equation (13), “T₁” is 0.2, “T₂” is 0.8, “a” is 1.0, and “c” is 0.1

(2) Effect:

Hereinafter, effect to set the weight is explained. With regard to a weight function shown in FIG. 10, in the same way as the first embodiment, if the first light source luminance is smaller than the second light source luminance, a weight is assigned to the first light source luminance. If the second light source luminance is smaller than the first light source luminance, a weight is assigned to the second light source luminance. However, if a difference between the light source luminance and the second light source luminance is larger than a threshold T₂, a larger weight is assigned to the first light source luminance. The reason is explained.

The case that a histogram of the input image is shown in FIG. 11 is explained. The histogram of FIG. 11 is acquired from the input image which a bright point exists in a dark background, such as fireworks or a starry sky. As to the input image having the histogram of FIG. 11, the first light source luminance (based on a maximum of gradation value of the input image) is a bright gradation value having a low frequency. Accordingly, as shown in FIG. 11, a backlight luminance is set as a very high value.

On the other hand, the second light source luminance (based on an average of brightness of the input image) is a dark gradation value having a high frequency. Accordingly, as shown in FIG. 11, a backlight luminance is set as a low value. In a displayable range of the image display unit 18 by the first light source luminance, a bright gradation value having a low frequency is within the displayable range. However, a dark gradation value having a high frequency is outside the displayable range.

On the other hand, in a displayable range of the image display unit 18 by the second light source luminance, a dark gradation value having a high frequency is within the displayable range. However, a bright gradation value having a low frequency is outside the displayable range. Briefly, a maximum of the gradation value is largely apart from an average of the gradation value in the input image. If a difference between the first light source luminance and the second light source luminance is large, any of the first light source luminance and the second light source luminance is not a suitable light source luminance.

Accordingly, if the second light source luminance is smaller than the first light source luminance, the second light source luminance is basically set as the output light source luminance, in the same way as the first embodiment. However, if the difference between the first light source luminance and the second light source luminance is very large, as shown in FIG. 10, a larger weight is assigned to the first light source luminance. In this case, the output light source luminance is set between the first light source luminance and the second light source luminance. As a result, the output light source luminance having a good balance on both the image quality and the power consumption is acquired.

As mentioned-above, in the second embodiment, as to various input images, the image display apparatus 10 which displays an image having a high visual contrast with a reduced power consumption can be presented.

### The Third Embodiment

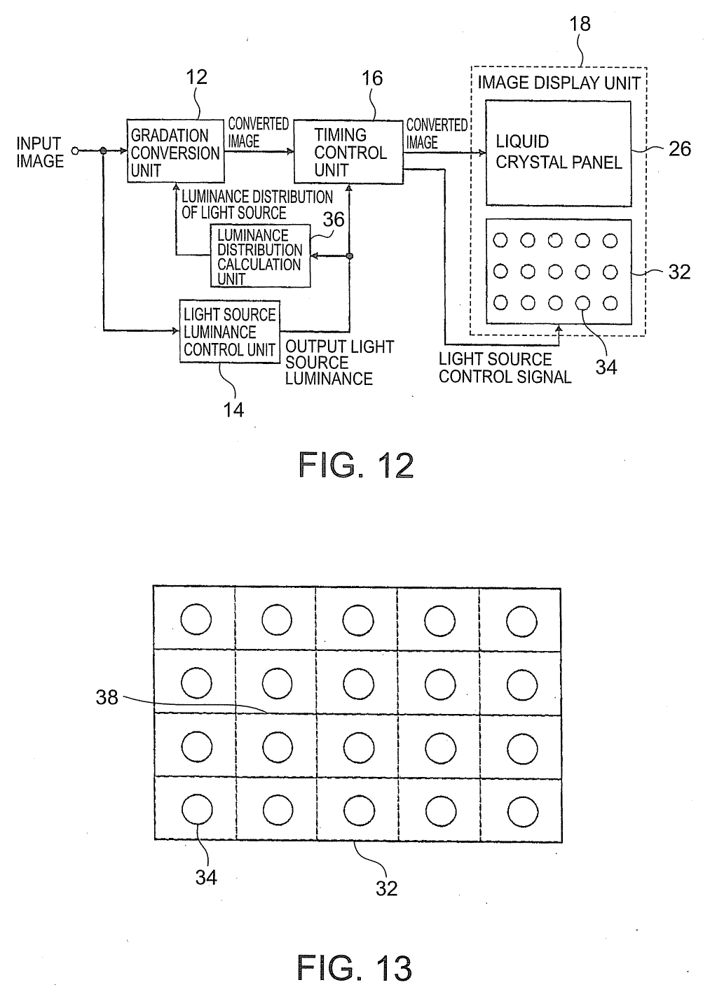

Hereinafter, the image display apparatus 10 of the third embodiment is explained by referring to FIGS. 12˜16. Basic component of the image display apparatus 10 of the third embodiment is same as the first embodiment. However, in the third embodiment, a plurality of light sources 34 is set on the backlight 32, and a light source luminance is controlled for each light source 34.

(1) Component of the Image Display Apparatus 10:

As shown in FIG. 12, the image display apparatus 10 includes a gradation conversion unit 12, a light source luminance control unit 14, a timing control unit 16, an image display unit 18, and a luminance distribution calculation unit 36. The image display unit 18 is a liquid crystal display unit, which is contained of a liquid crystal panel 26 (a light modulator) and a backlight 28 (having a plurality of light sources) set at the back of the liquid crystal panel. Image data of an input image is inputted to the gradation conversion unit 12 and the light source luminance control unit 14.

In the light source luminance control unit 14, in the same way as the first embodiment, the first light source luminance calculation unit 20 calculates the first light source luminance and the second light source luminance calculation unit 22 calculates the second light source luminance, for each divided region of the input image corresponding to each light source 34 of the backlight 32.

The first light source luminance and the second light source luminance are input to the output light source luminance calculation unit 24. By weighted averaging the first light source luminance and the second light source luminance, the output light source luminance of each light source is calculated. The output light source luminance of each light source is input to the luminance distribution calculation unit 36 and the timing control unit 16.

In the luminance distribution calculation unit 36, based on a shape of luminance distribution when one light source 34 of the backlight 32 is emitting, a luminance distribution of light source of the backlight when the plurality of light sources is emitting by the output light source luminance is calculated. The luminance distribution of light source of the backlight is input to the gradation conversion unit 12.

In the gradation conversion unit 12, based on the luminance distribution of light source of the backlight, a gradation value of each pixel of the input image is converted, and converted image data is output.

In the timing control unit 16, timing of the converted image data (converted by the gradation conversion unit 12) and timing of the output light source luminance (calculated by the light source luminance control unit 14) are controlled. Briefly, the converted image data is output to the liquid crystal panel 26, and the output light source luminance as a light source control signal is output to the backlight 32.

In the image display unit 18, the converted image data is written into the liquid crystal panel 26. Furthermore, by each light source 34 (of the backlight 32) emitting based on the light source control signal, the input image is displayed on the image display unit 18. Hereinafter, operation of each unit is explained in detail.

(2) The Light Source Luminance Control Unit 14:

In the light source luminance control unit 14, the output light source luminance of each light source 34 of the backlight 32 is calculated. In the first embodiment, a maximum and an average are calculated from an entire input image, and the first light source luminance and the second light source luminance are calculated using the maximum and the average. By weighted averaging the first light source luminance and the second light source luminance, the output light source luminance is calculated.

However, in the third embodiment, the first light source luminance and the second light source luminance are respectively calculated for each region of the input image corresponding to each light source 34 of the backlight 32. By weighted averaging the first light source luminance and the second light source luminance, the output light source luminance is calculated.

For example, as shown in FIG. 13, as to the backlight 32 having five light sources along a horizontal direction and four light sources along a vertical direction, the input image is divided into 5×4 regions corresponding to each light source 34. A maximum and an average of each divided region are respectively calculated. The first light source luminance and the second light source luminance are calculated using the maximum and the average of each divided region. By weighted averaging the first light source luminance and the second light source luminance, the output light source luminance of each light source 34 corresponding to each divided region is calculated.

As mentioned-above, one light source 34 corresponds to one divided region 38. However, a plurality of light sources 34 may correspond to one divided region 38. Furthermore, except for the input image equally divided into each region by the number of light sources, the input image may be divided into each region so that a part of each region overlaps, and a maximum and an average of each region maybe calculated. The output light source luminance of each light source 34 is output to the luminance distribution calculation unit 36 and the timing control unit 16.

(3) The Luminance Distribution Calculation Unit 36:

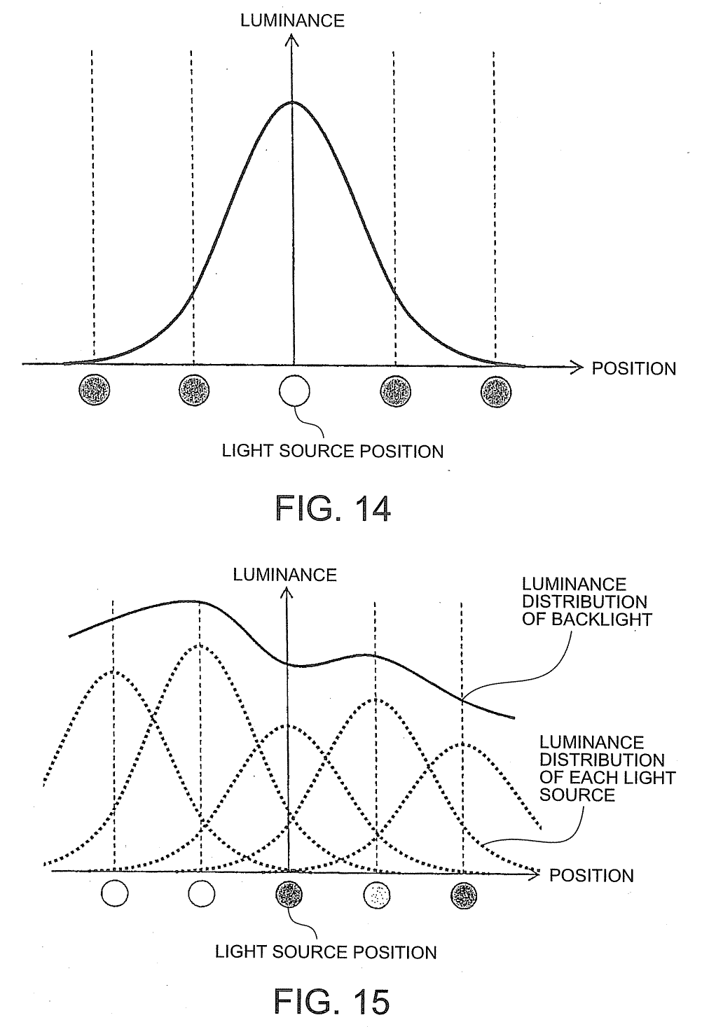

In the luminance distribution calculation unit 36, a luminance distribution of the backlight 32 is actually calculated. FIG. 14 shows a luminance distribution of one light source 34 of the luminance 32 when the one light source 34 is only emitting. In order to simplify the explanation, in FIG. 14, the luminance distribution is represented with one dimension, a horizontal axis represents a position of the light source, and a vertical axis represents a luminance. Each light source 34 is located at the lower position of FIG. 14, and the luminance distribution which one light source 34 at a center position is only emitting is shown.

As shown in FIG. 14, the luminance distribution which one light source 34 is emitting spreads to a position of another light source adjacent to the one light source. In order for the gradation conversion unit 12 to convert a gradation based on a luminance distribution of the backlight 32, by adding the luminance distribution (shown in FIG. 14) based on the output light source luminance of each light source 34, the luminance distribution of the backlight 32 is actually calculated.

FIG. 15 shows the luminance distribution of the backlight when a plurality of light sources 34 of the backlight 32 are emitting. In order to simplify the explanation, the luminance distribution is represented with one dimension. When each light source 34 at a lower position of FIG. 15 is emitting, each light source 34 has a luminance distribution as a dotted line in FIG. 15. By adding the luminance distribution of each light source 34, the luminance distribution of the backlight as a solid line in FIG. 15 is calculated.

(4) Modification of the Luminance Distribution Calculation Unit 36:

As to the luminance distribution of the light source 34 in FIG. 14, an approximate function of a measured luminance related with a distance from the light source 34 may be calculated and stored in the luminance distribution calculation unit 36. In the third embodiment, the luminance distribution of the light source 34 in FIG. 14 is calculated as relationship between the luminance and the distance from the light source 34, and stored in a ROM as a LUT.

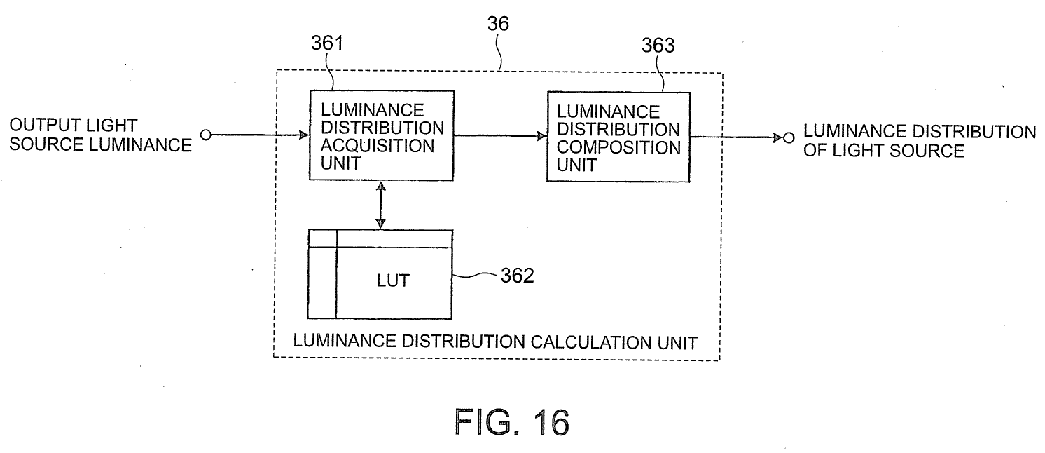

As shown in FIG. 16, the output light source luminance corresponding to each light source 34 is input to a luminance distribution acquisition unit 361. In the luminance distribution acquisition unit 361, a luminance distribution of each light source 34 is acquired from the LUT 362, and multiplies the luminance distribution with the output light source luminance of each light source 34. As a result, a backlight luminance distribution of each light source 34 is calculated as a dotted line in FIG. 15.

Next, in a luminance distribution composition unit 363, by adding the backlight luminance distribution of each light source 34, a luminance distribution of the backlight 32 is calculated as a solid line in FIG. 15, and input to the gradation conversion unit 12 as a luminance distribution of light source.

(5) The Gradation Conversion Unit 12:

In the gradation conversion unit 12, based on the luminance distribution of light source, a gradation value of each pixel of the input image is converted. Basic component of the gradation conversion unit 12 is same as the first embodiment. However, the light source luminance is different for each position of the input image. Accordingly, the equation (11) is replaced with a following equation (14).

$${L}_{{R}^{′}} ( x , y ) = \frac{{L}_{R} ( x , y )}{{I ( x , y )}^{1 / γ}} \\ {L}_{{G}^{′}} = ( x , y ) = \frac{{L}_{G } ( x , y )}{{I ( x , y )}^{1 / γ}} \\ {L}_{{B}^{′}} = ( x , y ) = \frac{{L}_{B } ( x , y )}{{I ( x , y )}^{1 / γ}} \qquad ( 14 )$$

In the equation (14), “I(x,y)” represents a luminance of the backlight 23 at a position (x,y) of the input image. A converted gradation value is calculated by operation of the equation (14). In the third embodiment, in the same way as the first embodiment, relationship among a gradation value L, a luminance distribution I(x,y) of light source, and a converted gradation value L′, is stored in the LUT. By referring to the LUT with a gradation value L(x,y) of the input image and the luminance distribution I(x,y) of light source, the converted gradation value L′(x,y) may be acquired.

(6) The Timing Control Unit 16:

In the timing control unit 16, timing to write the converted image data into the liquid crystal panel 26 and timing to apply the output light source luminance of each light source 34 to the backlight 32 are controlled. The converted image data is sent to the liquid crystal panel 26 with synchronizing signals (such as a horizontal synchronizing signal and a vertical synchronizing signal) generated by the timing control unit 16 to drive the liquid crystal panel 26. At the same time, a light source control signal to light each light source 34 of the backlight by a desired luminance is generated based on the output light source luminance, and sent to the backlight 32.

In the third embodiment, in the same way as the first embodiment, a LED light source is used as the light source 34 of the backlight 32, and a luminance of the LED light source is modulated by PWM control. Accordingly, from the timing control unit 16, a PWM control signal corresponding to each light source 34 is generated based on the output light source luminance, and sent to the backlight 32 as the light source control signal.

(7) The Image Display Unit 18:

As mentioned-above, the image display unit 18 contains the liquid crystal panel 26 as a light modulator and the backlight 32 (to modulate a luminance of the light source 34) set on the back of the liquid crystal panel 26. The image display unit 18 writes converted image data (output from the timing control unit 16) into the liquid crystal panel 26 (light modulator), and lights the backlight 32 based on the light source control signal (output from the timing control unit 16) of each light source 34 to display the input image. In the third embodiment, a LED light source is used as the light source 34 of the backlight 32.

(8) Effect:

As mentioned-above, in the third embodiment, as to various input images, the image display apparatus 10 which displays an image having the high visual contrast with the reduced power consumption can be presented.

(Modifications)

The present invention is not limited to above-mentioned embodiments, and can be variously modified without deviating from the purport.

(1) Modification 1:

In above-mentioned embodiments, the liquid crystal display apparatus of a transparent type as the image display unit having combination of the liquid crystal panel 26 and the backlight 32 is explained. However, the present invention can be applied to the image display unit 18 of various types except for the transparent type.

For example, the image display unit 18 of a projection type having combination of the liquid crystal panel 26 (light modulator) and a light source such as a halogen light source, can be applied. Furthermore, the image display unit 18 of another projection type having the halogen light source and a digital micro mirror device (light modulator) to display the image by controlling reflection of a light from the halogen light source, can be applied.

(2) Modification 2:

In above-mentioned embodiments, a color of sub-pixel of each pixel is red, green, and blue. However, combination of other colors, for example, combination of red, green, blue, and white, may be used.

In the disclosed embodiments, the processing can be performed by a computer program stored in a computer-readable medium.

In the embodiments, the computer readable medium may be, for example, a magnetic disk, a flexible disk, a hard disk, an optical disk (e.g., CD-ROM, CD-R, DVD), an optical magnetic disk (e.g., MD). However, any computer readable medium, which is configured to store a computer program for causing a computer to perform the processing described above, may be used.

Furthermore, based on an indication of the program installed from the memory device to the computer, OS (operation system) operating on the computer, or MW (middle ware software) such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

Other embodiments of the invention will be apparent to those skilled in the art from consideration of the specification and embodiments of the invention disclosed herein. It is intended that the specification and embodiments be considered as exemplary only, with the scope and spirit of the invention being indicated by the claims.

What is claimed is:

1. An apparatus for displaying an image comprising a plurality of pixels, each pixel comprising a plurality of sub-pixels, each sub-pixel corresponding to each color, the apparatus comprising:
a light source unit configured to emit a light having a luminance;
a light modulator configured to modulate a transmittance or a reflectance of the light based on a gradation of each sub-pixel;
a first calculation unit configured to select a largest value from brightness data of the sub-pixels of each pixel in a region of the image, and calculate a first light source luminance using the largest value;
a second calculation unit configured to calculate an average of the largest value of each pixel in the region, and calculate a second light source luminance using the average;
a third calculation unit configured to compare the first light source luminance with the second light source luminance, and calculate an output light source luminance as a weighted average of the first light source luminance and the second light source luminance by setting a larger weight to a smaller one of the first light source luminance and the second light source luminance;
a gradation conversion unit configured to convert a gradation of each sub-pixel of the region using the output light source luminance; and
a control unit configured to output a converted gradation of each sub-pixel of the region to the light modulator, and control the light source unit to emit the light having the output light source luminance.

2. The apparatus according to claim 1, wherein
the first calculation unit selects a maximum from largest values of all pixels in the region, and calculates a maximum luminance as the first light source luminance using the maximum.

3. The apparatus according to claim 1, wherein
the second calculation unit selects the largest value from brightness data of the sub-pixels of each pixel in the region, calculates the average of largest values of all pixels in the region, and calculates the second light source luminance so that the average is equal to a center value between a minimum and a maximum of brightness data displayable by the light modulator.

4. The apparatus according to claim 1, wherein
the third calculation unit sets the weight based on a difference between the first light source luminance and the second light source luminance.

5. The apparatus according to claim 1, wherein
the third calculation unit determines the weight to set the first light source luminance as the output light source luminance when the first light source luminance is smaller than the second light source luminance, and determines the weight to set the second light source luminance as the output light source luminance when the second light source luminance is smaller than the second light source luminance.

6. The apparatus according to claim 1, wherein
the third calculation unit calculates a difference by subtracting the second light source luminance from the first light source luminance, and sets a first weight to the first light source luminance when the difference is smaller than a first threshold or larger than a second threshold larger than the first threshold, and
the first weight is larger than a second weight to set to the first light source luminance when the difference is between the first threshold and the second threshold.

7. The apparatus according to claim 1, wherein
the region is an entire region of the input image.

8. The apparatus according to claim 1, wherein
the region is a divisional region of the image, and
the light source unit has a plurality of light sources each emitting the light to the light modulator in correspondence with the divisional region.

9. A method for displaying an image comprising a plurality of pixels, each pixel comprising a plurality of sub-pixels, each sub-pixel corresponding to each color, the method comprising:
selecting a largest value from brightness data of the sub-pixels of each pixel in a region of the image;
calculating a first light source luminance using the largest value;
calculating an average of the largest value of each pixel in the region;
calculating a second light source luminance using the average;
comparing the first light source luminance with the second light source luminance;
calculating an output light source luminance as a weighted average of the first light source luminance and the second light source luminance by setting a larger weight to a smaller one of the first light source luminance and the second light source luminance;
converting a gradation of each sub-pixel of the region using the output light source luminance;
outputting a converted gradation of each sub-pixel of the region to a light modulator to modulate a transmittance or a reflectance of a light from a light source unit; and
controlling the light source unit to emit the light having the output light source luminance.
